(19) United States
(12) Patent Application Publication
(10) Pub. No.: US 2022/0398222 A1
(43) Pub. Date: Dec. 15, 2022

(54) PROGRAMATIC MODIFICATIONS TO FILE CONTENT

(71) Applicant: Microsoft Technology Licensing, LLC, Redmond, WA (US)

(72) Inventor: Rolly SETH, Redmond, WA (US)

(21) Appl. No.: 17/342,835

(22) Filed: Jun. 9, 2021

(51) Int. Cl. G06F 16/176; G06F 16/178; G06F 16/11; G06F 16/16; G06F 16/17

(52) U.S. Cl. CPC G06F 16/1767; G06F 16/178; G06F 16/122; G06F 16/16; G06F 16/1734

(57) ABSTRACT

Non-limiting examples of systems, methods, and devices for programmatic modifications to files are disclosed herein. In an implementation, content of a file is auto-updated based on an association with an external resource. The external resource may access a data source and monitor for real-time status updates. When a status update is observed, the external resource captures the change and updates a version of the content based on the captured change. If necessary, the external resource may capture the change in a first format and transform the captured change into a second format that is compatible with the version of the content. State information of the updated version is then sent to the file and the content of the file may be updated according to the state information.

### BACKGROUND

Collaborative management tools may be implemented to coordinate collaborative activities between individuals working on a common task. For example, collaborative software may be employed to generate and/or edit productivity documents such as word documents, spreadsheets, slide-shows, videos, and the like. A main version of the productivity document may be stored on a server of a distributed computing system (e.g., cloud computing system) and accessed by collaborators. Modifications made on local client devices by the collaborators are received by the cloud based server, merged at the server into the main version, and merged updates may be pushed to the local client devices of the collaborators.

Productivity documents may comprise content that is time sensitive (i.e., has a value and/or feature that changes over time). Thus, a productivity document may become stale (i.e., outdated) shortly after its creation. If a productivity document is to reflect up-to-date information, then a user must verify the accuracy of the information in the existing document and make any necessary edits. With the support of a cloud-based data structure, multiple users can modify the same document and view modifications made by other collaborators. However, users are not always able to make the edits that are necessary to keep a document fresh. For example, when in a presentation mode, a user may not be able to change elements of the presentation document. Similarly, updates cannot be made by a user when the user does not have access to the document (e.g., the document is in a stored mode, etc.). Additionally, a document may be access protected, and thereby, blocks a user's ability to edit the document (e.g., when in a read-only mode, etc.).

Linked objects may also be used to update content of a productivity document. For example, a spreadsheet object may be inserted into a word processing document and linked to cells in a spreadsheet document. Updates to the spreadsheet may then be reflected in the word processing document. However, linked data is stored in the source file and only a representation of the linked data is displayed via the linked object. As a result, a linked object may fail when the source file is moved, or the linked object application is unavailable.

The subject matter claimed herein is not limited to embodiments that solve any disadvantages or that operate only in the environments described above. Rather, this background is only provided to illustrate an exemplary technology area in which some embodiments described herein may be practiced.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter. Additional aspects, features, and/or advantages of examples will be set forth in part in the description which follows and, in part, will be apparent from the description or may be learned by practice of the disclosure.

Non-limiting examples of the present disclosure describe systems, methods, and devices for facilitating programmatic modifications to file content. In an implementation, an instance of a sub-component comprising content of a file may be shared with an external resource, wherein the sub-component comprises state information and logic for updating the state information Subsequent to entering an asynchronous mode, the external resource may be activated and begin monitoring a data source remote to the file for a change to data associated with the content. The external resource may detect the change to data and generate a captured update. Subsequent to the external resource updating the instance of the sub-component based on the captured updated, the state information of the sub-component may be modified to reflect a state of the instance of the sub-component. Updating the state information of the sub-component may alter a view of the content in a user interface (e.g., when permission settings of the logic permit).

### BRIEF DESCRIPTION OF THE DRAWINGS

Non-limiting and non-exhaustive examples are described with reference to the following figures:

FIG. 1 is a schematic diagram illustrating an example distributed computing environment for facilitating programmatic modifications to file content.

FIG. 2A is a schematic diagram illustrating an implementation of programmatic modifications to file content.

FIG. 2B is a schematic diagram illustrating an implementation of programmatic modifications to file content.

FIG. 3 illustrates a method for an implementation of programmatic modifications to file content.

FIG. 4A illustrates a method for an implementation of programmatic modifications to file content.

FIG. 4B illustrates a method for an implementation of programmatic modifications to file content.

FIG. 5 is a schematic diagram illustrating an example collaboration architecture for facilitating programmatic modifications to file content.

FIG. 6 is a schematic diagram illustrating an operational sequence of programmatic modifications to file content.

FIG. 7 is a simplified block diagram of a distributed computing system in which aspects of the present disclosure may be practiced.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Non-limiting examples of systems, methods, and devices for programmatic modifications to file content are disclosed herein. An external resource is a resource located external to a productivity document/file and designed to collaborate on the productivity document/file (e.g., make automatic edits to the productivity document, automatically save modified versions of the productivity file, etc.). The external resource may be associated with a portion, element, sub-component, and/or object of a productivity document. To associate the external resource with the sub-component, a user may insert or otherwise place an object onto a workspace of the productivity document, wherein the object is configured to link to the external resource. Alternatively, a user may select the sub-component and request to link the sub-component with the external resource. For example, a user may highlight a portion of text in a document and select from a menu the option to associate an external resource with the highlighted text. Other methods of associating the external resource with the sub-component are possible and considered herein.

Update criteria may also be associated with the sub-component, the productivity document, and/or the external resource. The update criteria may describe thresholds for updating content, one or more data sources the external resource is to monitor, metrics for monitoring data source(s), etc. The update criteria may comprise permission settings that describe circumstances in which the file and/or sub-component may be updated. For example, the update criteria and/or permission settings may permit and/or prohibit updates when the productivity file is in an editing mode, a presentation mode, a saved mode, or other asynchronous mode. The update criteria may require the file to be exported to video when updates are made. The permission settings may be altered after activation of the external resource.

The sub-component may comprise text content, an image content, a graph content, table content, audio content, video content, and the like. The content of the sub-component may be time sensitive. Examples of time sensitive content include, but are not limited to, stock prices, periodic financial information, census data, emerging research, social media feeds, sports and/or gaming statistics, video feeds, audio feeds, image feeds, gaming feeds, and the like.

Upon activation, an external resource may detect when an associated sub-component has become stale (e.g., the time sensitive content is outdated). For example, the external resource may monitor a data source (e.g., a website) for changes to information hosted, presented, or otherwise provided by the data source (e.g., social media feed). The external resource may determine (e.g., based on a metric and/or threshold) that the change is significant.

In response to determining the change is significant, the external resource may capture the changed data, and update the sub-component and/or a version of the sub-component based on the captured change and in accordance with any update criteria. The external resource may then save and/or export the updated file and initiate transmission of a notification comprising details of the changes made to the file. The details of the changes may indicate that an update is available, may indicate that an update has been performed and provide a link to a saved version of the updated file, etc. The notification may be transmitted via email, text, chat, instant messaging, and the like.

The systems, methods, and devices for programmatic modifications to file content described herein facilitate automatic updates to portions, elements, sub-component, and/or objects of a productivity document. Existing solutions require a document to be accessible to, and editable by, a user in order for updates to be made and/or saved. The systems, methods, and devices described herein provide an improvement over existing solutions at least by providing an inventive means for updating portions, elements, sub-components, and/or objects during asynchronous modes (e.g., a saved mode, a presentation mode, a read-only mode, when a user does not have permission to edit a document, etc.). Additionally, unlike existing solutions, the association between the document and the external resource will not break if the file is saved in a different location (e.g., new folder) or if the sub-component is copied to a different application (e.g., from a spreadsheet to a word document, from a word document to a slide presentation, etc.).

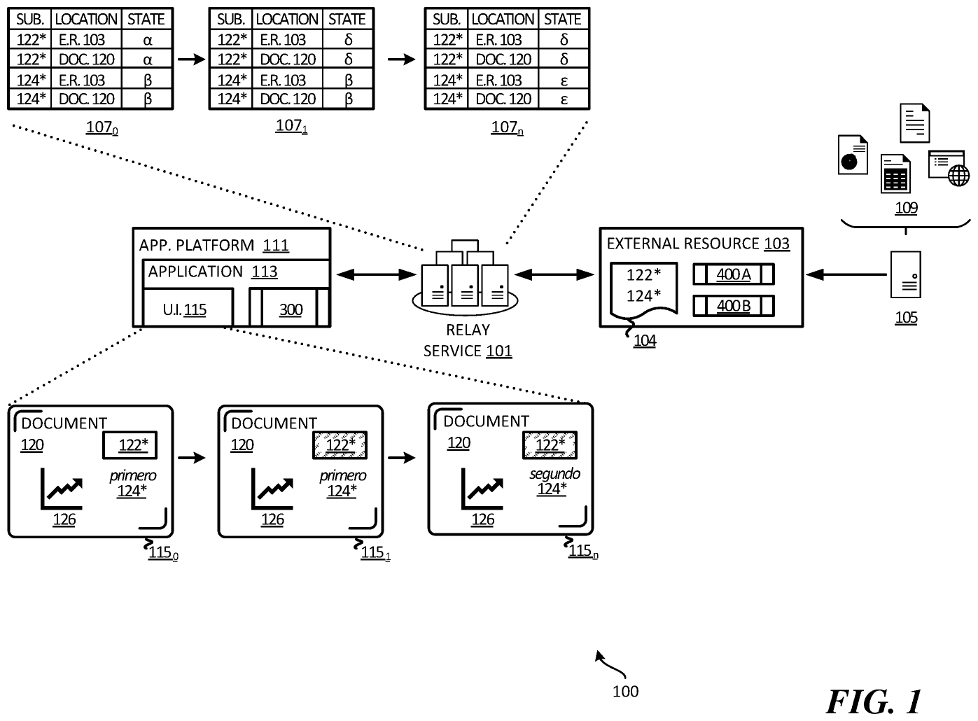

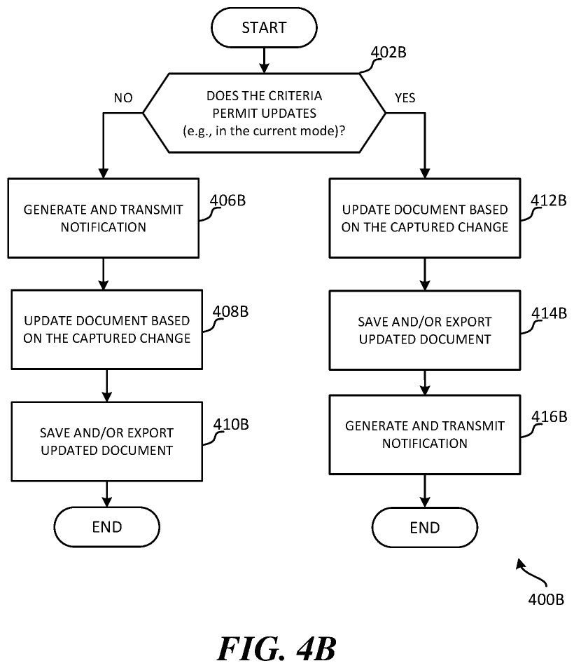

Referring now to the drawings, FIG. 1 is a schematic diagram illustrating an example computing environment 100 for facilitating programmatic modifications to file content. Computing environment 100 includes relay service 101, external resource 103, server computing device 105, and application platform 111. Relay service 101 is representative of any physical or virtual computing resource, or combination thereof, suitable for ordering incoming operations, broadcasting the operations to connected clients, and storing relay data in the form of summary operations, of which computing device 700 is representative. Relay service 101 may synch state information and/or content of shared sub-components. External resource 103 is illustrative of executable program code for implementing operations 400A and 400B (as illustrated by process 400A of FIG. 4A and process 400B of FIG. 4B), of which external resource module 720 is representative. External resource 103 collaborates on image object 122* and text object 124* via component instance 104, which comprises a version of image object 122* and a version of text object 124*.

Server computing device 105 is illustrative of one or more servers that may host one or more application services 109. Application services 109 may include one or more of personal information management services (email, calendar, etc.), document productivity services (word processing, spreadsheets, presentations, and collaboration, etc.), gaming services, social networking services, media services (music, videos, etc.), and e-commerce services, as well as any other service, combination of services, or variations thereof.

Application platform 111 is representative of any physical or virtual computing resource, or combination thereof, suitable for executing application 113, of which computing device 700 is representative. Examples of application platform 111 include, but are not limited to, desktop computers, laptop computers, tablet computers, mobile phones, wearable devices, virtual machines, and containers, as well as any variation, combination, or collection thereof.

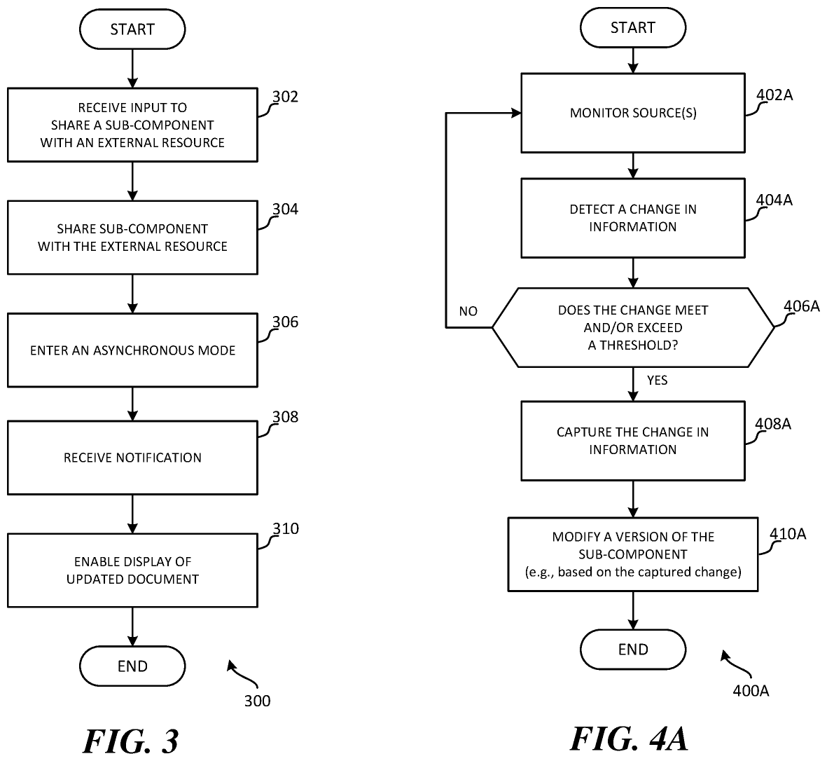

Application 113 is implemented in software and, when executed by application platform 111, renders user interface 115. Application 113 is implemented in program instructions that comprise various software modules, components, and other elements of the application. Update operation 300 (as illustrated by process 300 of FIG. 3) is representative of some of the functionality that may be provided by one or more of the software elements in application 113. Some commercial examples of application 113 include, but are not limited to, Microsoft® PowerPoint®, Prezi®, Google® Slides, Microsoft® Excel®, Google® Sheets, Microsoft® Word, etc. Application 113 may be a locally installed and executed application, a desktop application, a mobile application, a streamed (or streaming) application, a web-based application that is executed in the context of a web-browser, or any other type of application capable of employing update module 300. Application 113 and/or document 120 may have multiple modalities (e.g., an editing mode, a saved mode, a presentation mode, read-only mode, etc.).

In operation, users may engage with application 113 to generate and/or edit productivity documents. A user may create and/or edit document 120. A user may also share or otherwise associate one or more portions, objects, sub-components, and/or elements of document 120 with external resource 103. Document 120 comprises image object 122*, text object 124*, and graphic object 126. For exemplary purposes, image object 122* comprises image data, text object 124* comprises an alphanumeric value, and graphic object 126 comprises a graphical representation of data. It is also assumed for exemplary purposed that image object 122* and text object 124* are shared with external resource 103 but not graphic object 126. Document 120 may include other objects, sub-components, and/or elements in addition to or in place of those disclosed herein.

External resource 103 may be inactive until triggered. For example, external resource 103 may be activated upon sharing image object 122* and/or text object 124*, when application 113 and/or document 120 enters an asynchronous mode, and/or when selected by a user for activation (e.g., through a menu option). Once activated, external resource 103 may monitor server computing device 105 and/or application services 109 for changes (e.g., updates, additions, deletions, new content, etc.) to data sourced, obtained, derived, and/or otherwise reflected by image object 122* and text object 124*. After a change is detected, external resource 103 may capture (e.g., parses, pulls, grabs, replicates, obtains, etc.) information pertaining to the change and update component instance 104 accordingly.

In the present example, application 113 is in a presentation mode, and external resource 103 is active. The state information of image object 122* and text object 124* are synched with component instance 104 as shown in table 107₀. Initially, application 113 renders document 120 in user interface 115₀. Accordingly, image object 122* has an initial appearance (i.e., no hashing), text object 124* has an initial alphanumeric value/text string (i.e., primero), and graphic object 126 has an initial characteristic (i.e., line graph). Other elements may be presented in user interface 115₀ in addition to or in place of those disclosed herein.

Subsequent and/or in response to detecting a change to information associated with image object 122*, external resource 103 may capture the change and update component instance 104 according to the captured change. Subsequent and/or in response to updating component instance 104, relay service 101 may update the state information of component instance 104 to reflect the change. Relay service 101 may then push the updated state information to image object 122* of document 120. The updated state information may be used to update the content of image object 122* in accordance with any update criteria (e.g., upon application 113 receiving the updated state information, after a delay, etc.). Relay service 101 may then record the updated state information of image object 122* to reflect the completed synch operation as shown in table 107₁.

Subsequent to updating the state information of image object 122*, application 113 may render image object 122* in user interface 115₁ having a subsequent appearance reflective of the update (e.g., hashing). Text object 124* is displayed having its original alphanumeric value (i.e., primero) because external resource 103 has not yet detected a change associated with text object 124*. Graphic object 126 is displayed having its original characteristic (i.e., line graph) because graphic object 126 is not shared with external resource 103 and therefore, cannot have its content updated by external resource 103.

Subsequent to modifying image object 122*, external resource 103 may detect a change to information associated with text object 124*. External resource 103 may capture the change and update component instance 104 according to the captured change. Subsequent and/or in response to updating component instance 104, relay service 101 may update the state information of component instance 104 to reflect the change. Relay service 101 may then push the updated state information to text object 124* of document 120. The updated state information may be used to update the content of text object 124* in accordance with any update criteria (e.g., upon application 113 receiving the updated state information, after a delay, etc.). Relay service 101 may then record the updated state information of text object 124* to reflect the completed synch operation as shown in table 107ₙ.

Subsequent updating the state information of text object 124*, application 113 may render user interface 115ₙ. in which text object 124* is displayed having a subsequent alphanumeric value reflective of the change (e.g., segundo). Image object 122* is displayed having the subsequent appearance (e.g., hashing) because external resource 103 did not detect an additional change associated with image object 122*. Graphic object 126 is displayed having its original characteristic (i.e., line graph) because graphic object 126 is not shared with external resource 103 and therefore, cannot have its content updated by external resource 103.

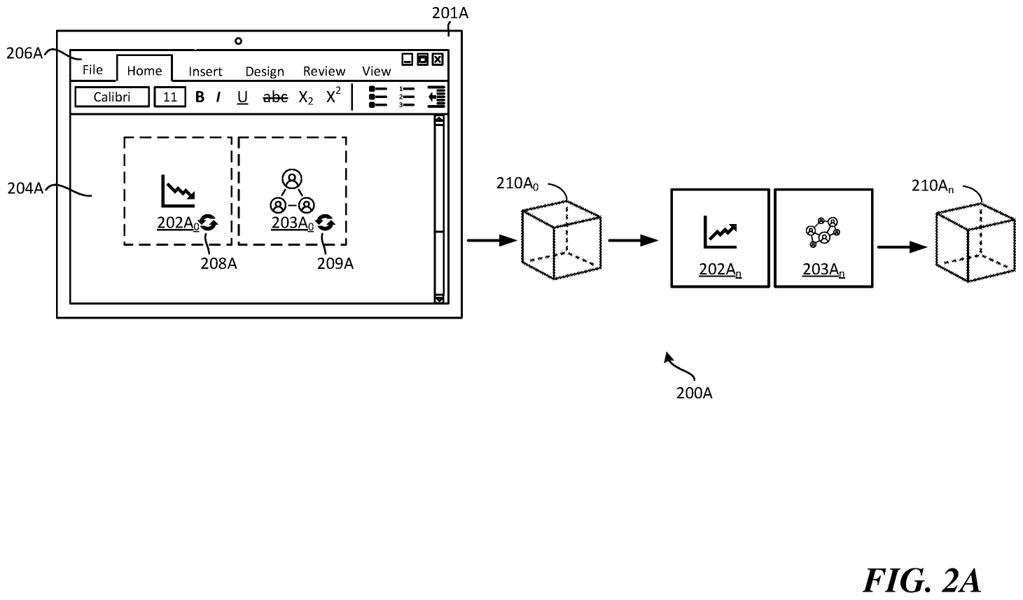

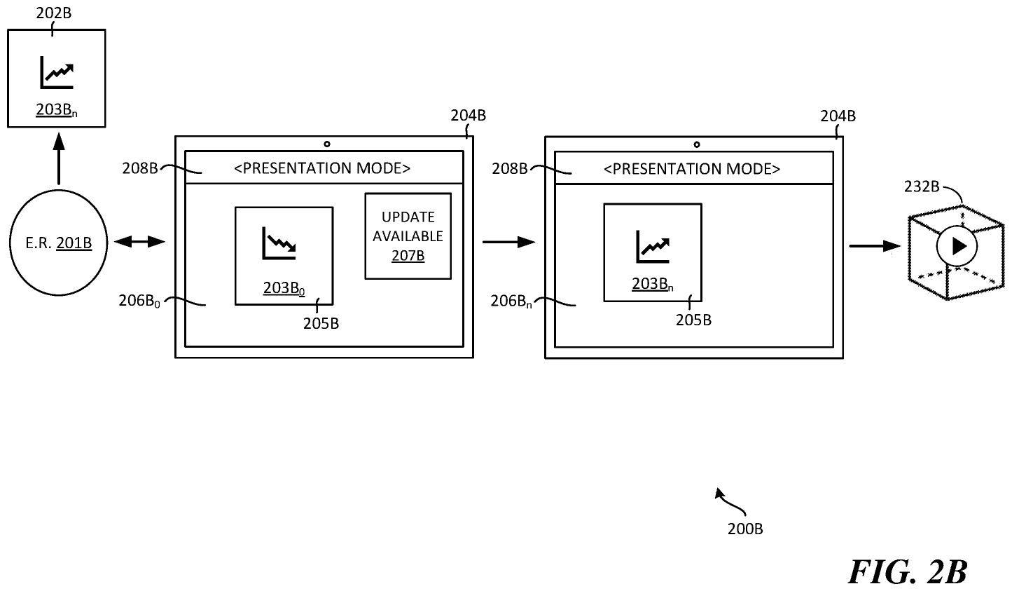

FIG. 2A is a schematic diagram of a computing environment 200A illustrating an implementation of programmatic modifications to file content. Computing environment 200A comprises computing device 201A, presentation file 210A₀, updated sub-components 202A₁ and 203Aₙ, and updated presentation file 210Aₙ. Referring parenthetically to the steps in FIG. 3 and FIG. 4A, computing device 201A displays sub-components 202A₀ and 203A₀ in user interface 204A of application 206A. Application 206A may receive an input (e.g., menu selection, command, gesture, etc.) to add an external resource to presentation file 210A₀ or otherwise share an element of presentation file 210A₀ (step 302). In response to the input, external resource 208A is associated/shared with a graph object of sub-component 202A₀, and external resource 209A is associated/shared with a social-media data object of sub-component 203A₀ (step 304). Though external resources 208A and 209A are shown as separate entities, it is contemplated herein that external resources 208A and 209A may be a single entity.

External resources 208A and 209A may be activated in response to a trigger (step 306). Example triggers include, but are not limited to, sharing elements of a productivity document with an external resource, changing modality to an asynchronous mode (e.g., entering a presentation mode, closing a productivity document, or otherwise entering a stored modality, opening a productivity document in a read-only mode, etc.), selecting and/or gesturing via a user interface to activate the external resource, and the like. Additionally, external resources 208A and 209A may be deactivated (e.g., by removing an association with a shared sub-component, by deleting a shared sub-component, etc.).

External resources 208A and 209A monitor one or more data sources (not shown) for changes to information associated with the graph of sub-component 202A₀ and the social-media data object of sub-component 203A₀, respectively (step 402A). The data sources may be remote to presentation file 210A₀ and may include server computing devices, databases, application services, websites, and the like. External resources 208A and 209A may use live connectors and/or other application programming interfaces (APIs) to monitor the one or more data sources over a network (e.g., Internet, etc.) (not shown). The live connectors may be mentioned in a presentation document, assigned, added, provided in update criteria, etc. If permission is needed to access a data source, the permission may be realized, provided, or otherwise established via external resources 208A and 209A.

External resources 208A and 209A may detect a change when information at a data source is no longer consistent with the information associated with the graph of sub-component 202A₀ and/or the social-media data object of sub-component 203A₀, respectively (step 404A). An external resource may determine a change occurred based on a metric and/or machine learning techniques. An external resource may further determine a change is significant when data at a source differs from the content of the sub-component greater than or equal to a threshold amount (e.g., pixels of an image at a data source may change beyond a threshold amount, a data value may drop below or rise above a threshold amount, a timestamp of a social media post may be more recent than a threshold amount, etc.) (step 406A).

Subsequent and/or in response to determining the change to a value associated with the graph of sub-component 202A₀ is significant, external resource 208A captures the change (step 408A). The change may be captured in a first format, and if necessary, transformed into a second format that is compatible with presentation file 210A₀. External resource 208A (e.g., via a relay service) may then update, automatically (i.e., without user intervention), presentation file 210A₀ based on the captured change (step 410A). For example, external resource 208A may edit a value of the graph of sub-component 202A₀, remove and replace the graph of sub-component 202A₀, and/or otherwise modify the graph of sub-component 202A₀. Updated sub-component 202Aₙ reflects the update to the graph of sub-component 202A₀.

Subsequent and/or in response to updating the graph of sub-component 202A₀, external resources 208A may save an updated version of presentation file 210A₀ by overwriting presentation file 210A₀ or otherwise saving presentation file 210A₀ as updated presentation file 210Aₙ.

Similarly, in response to detecting a change in a value associated with the social-media data object of sub-component 203A₀, external resource 209A captures the change. The change may be captured in a first format, and if necessary, transformed into a second format that is compatible with presentation file 210A₀. External resource 209A (e.g., via a relay service) may then update, automatically (e.g., without user intervention), presentation file 210A₀ based on the captured change. For example, external resource 209A may edit a value of the social-media data object of sub-component 203A₀, remove and replace the social-media data object of sub-component 203A₀, and/or otherwise modify the social-media data object of sub-component 203A₀. Updated sub-component 203A₀. reflects the update to the social-media data object of sub-component 203A₀.

Subsequent and/or in response to updating the social-media data object of sub-component 203A₀, external resources 209A may save an updated presentation file 210A₀ by overwriting presentation file 210A₀ or otherwise saving presentation file 210A₀ as a updated presentation file 210Aₙ.

FIG. 2B is a schematic diagram of a computing environment 200B illustrating an implementation of programmatic modifications to file content. Computing environment 200B comprises external resource 201B, shared element 202B comprising updated content 203Bₙ, computing device 204B, and presentation video 232B. Computing device 204B may comprise user interface 206B₀ of application 208B, and user interface 206B₀ may comprise shared element 205B comprising content 203B₀. It is assumed for exemplary purposes that shared elements 202B and 205B are synched via a relay service (not shown).

Referring parenthetically to the steps in FIG. 3 and FIG. 4B, external resource 201B may determine, based on update criteria, when the modifications to shared element 202B may be synched with shared element 205B (step 402B). For example, when updates are not permissible, external resource 201B may refrain from pushing updates to application 208B until the mode of application 208B changes or other event triggers a permissible state according to the update criteria.

It is assumed for exemplary purposes that that the update criteria for shared element 205B requires an affirmative response to a notification prior to updating. As a result, external resource 201B generates notification 207B indicating there is an update available and transmits the notification to application 208B (step 406B). Application 208B receives the notification (step 308), and when the user selects notification 207B or otherwise indicates that updates are permissible, then external resource 201B may cause content 203B₀ to update to content 203Bₙ (step 408B). Subsequent and/or in response to updating to content 203Bₙ, external resource 201B may initiate, automatically based on the update criteria, generation of presentation video 232B comprising content 203Bₙ by exporting the updated presentation document (step 410B). Presentation video 232B may be saved by overwriting an existing presentation video or by saving presentation video 232B as a new document.

In an alternative embodiment, the updated criteria may indicate updates are permissible and may be implemented automatically. When automatic updates are permissible, external resource 201B may cause content 203B₀ to update to content 203Bₙ without first requiring user intervention/input (step 412B). Subsequent and/or in response to updating to content 203Bₙ, external resource 201B may initiate, automatically based on the update criteria, generation of presentation video 232B comprising content 203Bₙ by exporting the updated presentation document (step 414B). Presentation video 232B may be saved by overwriting an existing presentation video or by saving presentation video 232B as a new document. External resource 201B may then generate a notification describing any detected changes, modifications made (e.g. to a productivity file, sub-component, etc.), version histories of the presentation document, and the like, and may transmit the notification for display in a user interface (step 416B).

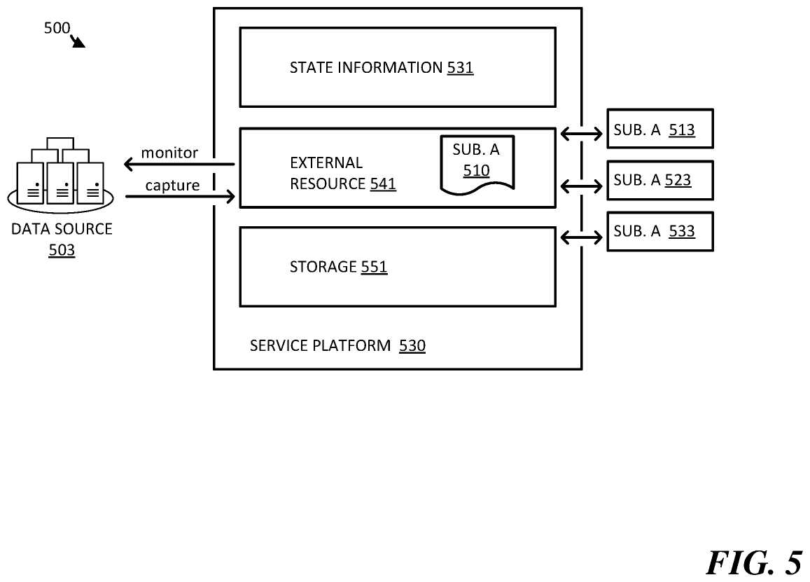

FIG. 5 illustrates relay service architecture 500, in an implementation. Relay service architecture 500 includes data source 503, service platform 530, and sub-components 513, 523, and 533. Data source 503 includes one or more servers that may host one or more application services. Application services may include one or more of personal information management services (email, calendar, etc.), document productivity services (word processing, spreadsheets, presentations, and collaboration, etc.), gaming services, social networking services, media services (music, videos, etc.), and e-commerce services, data storage services, as well as any other service, combination of services, or variations thereof.

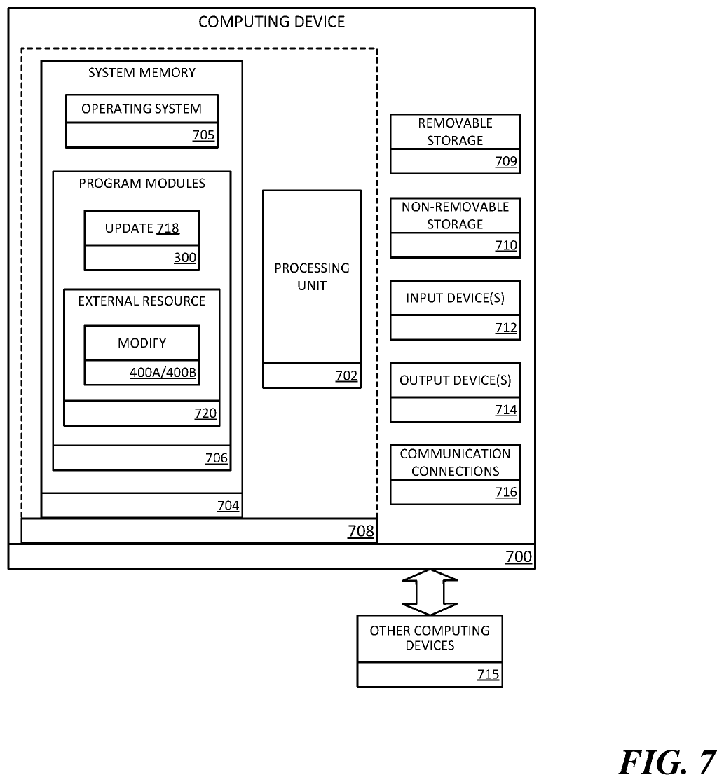

Service platform 530 includes various services (531, 541, and 551) that facilitate various aspects of file content modification. Service platform 530 is representative of any physical or virtual computing resource, or combination thereof, suitable for hosting all or part of an online service. Computing device 700, illustrated in FIG. 7, is representative of such computing resources, which include server computers, virtual machines, containers, and any variation, combination, or collection thereof. Taken together, the various services of service platform 530 are capable of modifying content of sub-components, such as processes 400A and 400B or variations thereof.

The various services of service platform 530 each provide a specific function. State information service 531, external resource service 541, and storage service 551 may run on separate computing systems or may be integrated on an integrated platform (as shown). State information service 531 orders (e.g., in a monotonically increasing sequence, etc.) incoming operations (e.g., state information, commands, etc.) and broadcasts the ordered operations to connected clients, applications, sub-components (e.g., Sub. A's 513-533), and the like.

External resource service 541 monitors data source 503 for changes to information associated with content of Sub. A's 510, 513, 523, and 533. Sub. A's 510, 513, 523, and 533 are variations of the same sub-component that may be integrated across disparate applications. For example, Sub. A 510 may be an object of external resource service 541, Sub. A 513 may be an object of a word document, Sub. A 523 may be an object of a slide-presentation, and Sub. A 533 may be an object of a canvas environment, each interconnected through service platform 530. An update to the content of one sub-component may trigger an update to one or all of the other connected sub-components. Update criteria associated with the sub-components may inform when an update may be incorporated with the content of the sub-component.

Storage service 551 stores data in the form of summary operations. Other services, roles, or other functionality that may be associated with a relay service may be included in service platform 530, in addition to or in place of those disclosed herein.

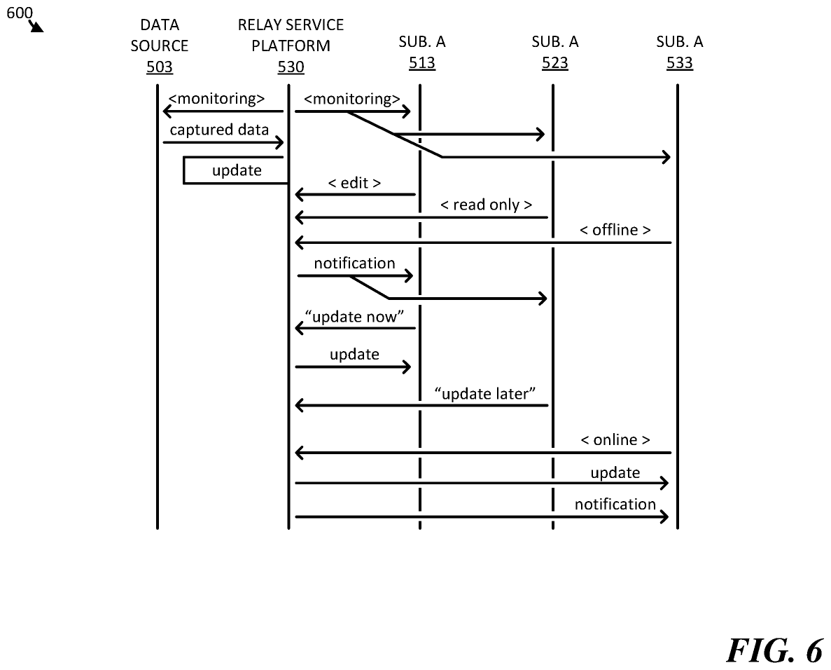

FIG. 6 illustrates operational sequence 600 to demonstrate an implementation of programmatic modifications to file content technology. In operation, service platform 530 monitors data source 503 for changes to information associated with content of Sub. A's 513, 523, and 533 as well as a connected sub-component hosted by service platform 530 (e.g. SUB. A 510 of FIG. 5). Information associated with the content may be of any file time (e.g., .JPG, .PDF, .DOC, .MSG, .DAT, .PPT, .XLS, .MP3, .AVI, .MPG, .SQL, .HTML, .JAVA, and the like), and changes to the information may be captured by relay service platform in a first file type and converted to a second file type that is compatible with a connected sub-component.

Service platform 530 also monitors state information associated with Sub. A's 513, 523, and 533 as well as a connected sub-component hosted by service platform 530 (e.g. Sub. A 510 of FIG. 5). State information may include changes made to content of the sub-component, modality of the sub-component, modality of an application environment of the sub-component, etc. The state information of a particular sub-component may be provided by the particular sub-component to service platform 530, by the application environment of the particular sub-component, and/or obtained by determining the state information of a connected sub-component on service platform 530 (e.g. Sub. A 510 of FIG. 5).

Service platform 530 may align the state information of one or all of the connected sub-components based on update criteria. A single update criteria may be shared across connected sub-components and/or unique to a each version of the sub-component. In the present example, service platform 530 updates (e.g., based on the captured date) the content and/or the state information of a connected sub-component on service platform 530 (e.g. Sub. A 510 of FIG. 5). Based on the monitoring data, service platform 530 may determine the modality of Sub. A 513 is editing, the modality of Sub. A 523 is read-only, and the modality of Sub. A 533 is offline. It is assumed for exemplary purposes that the update criteria associated with Sub. A's 513 and 523 indicates that a user is to be notified of an available update prior to updating the respective sub-component. The notification may comprise a description of multiple available updates and/or a request for when to incorporate the available updates. Alternatively, a single notification may be generated for each available update and may also comprise a request for when to incorporate an available update.

A response to the notification may be generated and transmitted via Sub. A 513 and/or an application environment associated with Sub. A 513 to service platform 530. In the present example, the response indicates that the update should be incorporated with Sub. A 513 “now.” As a result, service platform 530 updates the content and/or state information of Sub. A 513 without further delay. The update is based on the captured data and reflects the content and/or state information of the connected sub-component on service platform 530.

A response to the notification may be generated and transmitted via Sub. A 523 and/or an application environment associated with Sub. A 523 to service platform 530. In the present example, the response indicates that the update should be incorporated with Sub. A 523 “later.” As a result, service platform 530 delays updating the content and/or state information of Sub. A 523 (e.g., until the modality of Sub. A 513 changes, a period of time elapses, etc.).

The update criteria associated with Sub. A 533 may not permit updates to content when in an offline modality. As a result, service platform 530 may wait until the modality associated with Sub. A 533 changes to “online,” and may then automatically (i.e., without user input) update Sub. A 533. Service platform 530 may then generate and transmit a notification describing the update to Sub. A 533.

FIG. 7 is a block diagram illustrating physical components (e.g., hardware) of a computing device 700 with which aspects of the disclosure may be practiced. The computing device components described below may have computer executable instructions for facilitating programmatic modifications to file content. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 suitable for running one or more modification processing programs. The operating system 705, for example, may be suitable for controlling the operation of the computing device 700. Furthermore, embodiments of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 (e.g., update module 718 and external resource module 720) may perform processes including, but not limited to, the aspects, as described herein. Update module 718 may include update operation 300, and external resource module 720 may include modify operations 400A/400B, which may be deployed as described in FIGS. 1-6 herein.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 715. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable, and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by the computing device 700. Any such computer storage media may be part of the computing device 700. Computer readable media does not include a carrier wave or other propagated or modulated data signal. Computer readable storage device does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A computing device for facilitating programmatic modifications to a file, comprising:
a memory for storing executable program code;
a processor functionally coupled to the memory; and
the executable program code that, when executed by the computing device, directs the processor to:
share an instance of a sub-component comprising content of the file with an external resource, wherein the sub-component comprises state information and logic for updating the state information; and
subsequent to entering an asynchronous mode:
activate the external resource to monitor a data source remote to the file for a change to data associated with the content;
detect, via the external resource, the change to data associated with the content;
generate, via the external resource, a captured update by capturing the change to data associated with the content; and
subsequent to the external resource updating the instance of the sub-component based on the captured updated, update the state information to reflect a state of the instance of the sub-component.

2. The computing device of claim 1 wherein:
the logic includes update criteria related to the asynchronous mode; and
the executable program code further directs the processor to:
verify, based on the update criteria, a permission setting for updating the sub-component in the asynchronous mode;
when the update criteria indicates updates are permissible, update the sub-component; and
save the file comprising an updated sub-component.

3. The computing device of claim 1 wherein:
the logic includes update criteria related to the asynchronous mode; and
the executable program code further directs the processor to:
verify, based on the update criteria, a permission setting for updating the sub-component in the asynchronous mode; and
when the update criteria indicates updates are permissible, update a user interface based on the captured update.

4. The computing device of claim 1 wherein the executable program code further directs the processor to capture the change to the data when the change to the data meets or exceeds a threshold.

5. The computing device of claim 1 wherein the sub-component comprises one of text content, graph content, image content, video content, and audio content.

6. The computing device of claim 5 wherein to update the content, the executable program code directs the processor to replace, based on the captured update, at least one of the image content, the video content, and the audio content.

7. The computing device of claim 5 wherein to update the content, the executable program code directs the processor to edit, based on the captured update, at least one of the text content and the graph content.

8. A computer-implemented method for facilitating programmatic modifications to documents, comprising:
sharing an instance of a sub-component comprising content of a file with an external resource, wherein the sub-component comprises state information and logic for updating the state information; and
subsequent to entering an asynchronous mode:
activating the external resource to monitor a data source remote to the file for a change to data associated with the content;
detecting, via the external resource, the change to data associated with the content;
generating, via the external resource, a captured update by capturing the change to data associated with the content; and
subsequent to the external resource updating the instance of the sub-component based on the captured updated, updating the state information to reflect a state of the instance of the sub-component.

9. The computer-implemented method of claim 8 wherein the logic includes a permission setting for updating the sub-component.

10. The computer-implemented method of claim 9 wherein the method further comprises:
verifying the permission setting for updating the sub-component when in the asynchronous mode;
when the permission setting indicates updates are permissible, updating the sub-component; and
saving the file comprising the updated sub-component.

11. The computer-implemented method of claim 9 wherein the method further comprises:
verifying the permission setting for updating the content when in the asynchronous mode; and
when the permission setting indicates updates are permissible, causing display of a user interface comprising the content modified based on the captured update.

12. The computer-implemented method of claim 8 further comprising capturing the change to the data when the change to the data meets or exceeds a threshold.

13. The computer-implemented method of claim 8 wherein the sub-component comprises one of text content, graph content, image content, video content, and audio content.

14. The computer-implemented method of claim 13 wherein updating the content comprises replacing, based on the captured update, at least one of the image content, the video content, and the audio content.

15. The computer-implemented method of claim 13 wherein updating the content comprises editing, based on the captured update, at least one of the text content and the graph content.

16. A computer readable storage device comprising executable instructions that, when executed by a processor, cause the processor to:
while in an editing mode:
initiate display of a sub-component of a presentation file, wherein the sub-component comprises content, state information, and logic for updating the state information; and
share an instance of the sub-component with an external resource; and
while in an asynchronous mode:
receive an update to the state information, wherein the update is generated in association with the external resource modifying the instance of the sub-component; and
modify the content based on the update and in accordance with the logic.

17. The computer readable storage device of claim 16 wherein:
the logic comprises permission settings for updating the content while in the asynchronous mode; and
the executable instructions further cause the processor to, while in the asynchronous mode, alter a view of the sub-component comprising the content modified based on the update.

18. The computer readable storage device of claim 16 wherein:
the logic does not permit the content to be modified while in the asynchronous mode; and
the executable instructions further cause the processor to postpone modifying the content until the asynchronous mode is exited.

19. The computer readable storage device of claim 16 wherein executable instructions further cause the processor to export the presentation file to video subsequent to modifying the content.

20. The computer readable storage device of claim 16 wherein the sub-component comprises one of text content, graph content, image content, video content, and audio content.
